(19) United States
(12) Patent Application Publication
(10) Pub. No.: US 2008/0306840 A1
(43) Pub. Date: Dec. 11, 2008

(54) COMPUTER SYSTEM FOR ENHANCING SALES FORCE EFFECTIVENESS AND DOWNSTREAM ACCOUNT MANAGEMENT IN A MULTI-TIERED DEMAND CHAIN

(76) Inventors: Michael C. Houlihan, Forestville, CA (US); Lee N. Hueckel, Alamo, CA (US); Steven J. Murchie, Centennial, CO (US); John R. Houlihan, Round Rock, TX (US)

Correspondence Address: VIERRA MAGEN MARCUS & DENIRO LLP, 575 MARKET STREET SUITE 2500, SAN FRANCISCO, CA, 94105, US

(21) Appl. No.: 11/761,284

(22) Filed: Jun. 11, 2007

(51) Int. Cl. G06F 19/00; G06Q 90/00

(52) U.S. Cl. 705/28

(57) ABSTRACT

A software application program is disclosed for allowing an upstream channel member such as a supplier to enhance sales force automation and performance by making it easier to manage a downstream channel member such as a retailer.

### BACKGROUND OF THE INVENTION

1. Field of the Invention

The present invention relates to a computer system and method for enhancing sales force effectiveness and downstream account management in a multi-tiered demand chain.

2. Description of the Related Art

A retail distribution channel (i.e., demand chain) may be comprised of an upper tier, one or more middle tiers and a lower tier consisting of the end customers in the channel. In one distribution channel model, the upper tier is the supplier interested in building a brand within a geographic area. It could be for example a manufacturer, a producer or an importer. In this distribution channel model, the middle tier may be a distributor, or wholesaler. The end customer may be retailers in the geographic areas that sell directly to the consuming public. Other distribution channel models exist.

One of the most significant problems facing upper tier suppliers is understanding and driving inventory flow at the retail level. Traditionally, distributors have been responsible for managing the logistics of building brand recognition and meeting demand in a geographic area. Suppliers have relied upon distributors to balance a variety of conflicting priorities and demands, such as:
Gaining new distribution
Driving a mix of brands, product lines, packages, varieties and/or SKUs (Stock Keeping Units)
Preventing out-of-stock conditions and/or discontinuances
Ensuring promotion and program effectiveness
Increasing accountability throughout the demand chain
Maximizing use of sales representatives' face-to-face selling time.

A consequence of the growth and maturation of a distribution channel is that the number of suppliers in the channel increases, and often, distributors in the channel consolidate. The result is that distributors often become too busy to effectively represent the above-described priorities of a supplier to the retail accounts. New distribution goes overlooked, and, just as important, where new distribution has been established, there is often no follow-up and the new distribution is lost.

It has therefore become important for a supplier to manage execution by the distributor or other downstream channel. It has become more incumbent on the suppliers' sales representatives to make sure that the suppliers' products are being marketed and sold into the retail channels according to the suppliers' priorities. There is therefore a need for a system where suppliers and upper tier channel participants can manage the logistics of brand development and product demand at the retailer level and lower tier channel members.

### SUMMARY OF THE INVENTION

The invention, roughly described, relates to a software application program for allowing an upstream channel member such as a supplier to enhance sales force effectiveness and performance by making it easier to manage a downstream channel member such as a retailer (i.e., an “account”). The application program may include a back-end software application program running on one or more servers of the supplier (or in a shared environment managed and apportioned to multiple suppliers), and a front-end software application program running on one or more personal computers of the supplier sales representatives.

The back-end software application program allows a supplier to generate a number of rules relating to alerts that are created in association with one or more SKUs based on a health of the SKU. As used herein, the health of an account relates to whether sales of one or more SKUs are continuing consistently, or whether there is a negative sales event or trend. In embodiments, rules may be implemented at the SKU-level. In alternative embodiments, rules may be implemented for any level of a brand hierarchy (brand, line, variety, package, SKU, etc.) The server running the back-end application program may also store historical data gathered in relation to sales volume and trends for the supplier's accounts.

The front-end software application program allows a supplier rep to download account information from the server for accounts in his or her territory. The account information includes a listing of accounts, the historical sales volume and trends for the accounts, anecdotal reports and surveys from prior account visits, and the alerts relating to the health of a SKU for an account or group of accounts. The alerts are automatically displayed in association with an account when the account exhibits a negative buying trend.

The application program according to the invention provides several advantages allowing reps to manage downstream channel members. It allows reps to understand account buying trends, and to stay familiar with account history. It provides historical sales data and reports for prior account visits at a glance. It allows reps to make a more informed and focused inspection of an account retailer, specifically inspecting those aspects of an account deemed to be important by supplier management. After making such an inspection, the present system also provides reps with the tools to take appropriate action and to make reports quickly and easily as desired by supplier management.

Moreover, the creation of a cross-organizational set of rules drives sales force behavior. By having a consistent set of warnings and rankings, every sales rep views their territory in the same way, and it becomes easier, at least indirectly, to enforce sales priorities. A given set of rules may reflect a supplier's prioritization of reach (distribution depth), revenue (volume shipped) or retention (product mix and/or retailer consistency). The rule base may change at any time, reflecting short-term priorities such as promotions and/or new product roll-outs. One sort of alert may be for example, “This customer is an excellent candidate for new Brand X” or “This customer is an excellent candidate for a volume order this season.”

As a further advantage, reps can more effectively manage their relationships with the middle tier partner(s). By understanding what is happening at retail (which they do not directly service), the rep can guide/influence/educate their distributor partner to better service the retail end-customer.

In embodiments of the invention, the application program may further be useful in managing upstream relationships and activity. For example, a sales rep may need to make reports to other divisions within the supplier, such as sales, marketing, accounting and corporate management. The present invention may generate reports which may automatically be distributed to a variety of different departments within a supplier or elsewhere.

### BRIEF DESCRIPTION OF THE DRAWINGS

FIG. 1 is a block diagram of a computing environment capable of implementing the software application program of the present invention.

FIG. 2 is a block diagram of a network over which the software application program according to the present invention may be implemented.

FIG. 3 is an illustration of a graphical user interface including a window presented by the software application program according to the present invention.

FIG. 4 is an illustration of a graphical user interface including an alternative window presented by the software application program according to the present invention.

FIG. 5 is an illustration of a graphical user interface including a further alternative window presented by the software application program according to the present invention.

FIG. 6 is an illustration of a graphical user interface including a form which may be generated by the software application program according to the present invention.

FIG. 7 is an illustration of a graphical user interface including a window for setting up a field visit by the application program according to the present invention.

FIG. 8 is an illustration of a graphical user interface including an alternative window for setting up a field visit by the application program according to the present invention.

FIG. 9 is an illustration of a graphical user interface including a form generated by the application program according to the present invention for conducting a field visit to one or more accounts.

### DETAILED DESCRIPTION

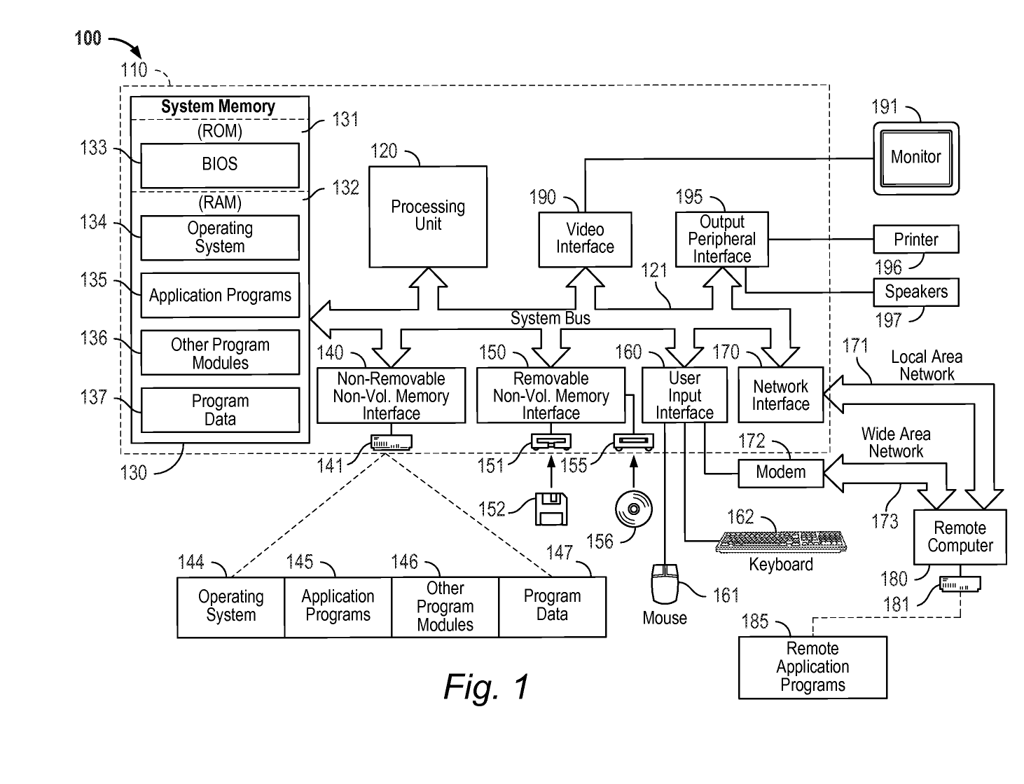

Embodiments of the present invention will now be described with reference to FIGS. 1 through 9, which in general relate to a system for enhancing sales force automation and downstream account management. The system described herein may include a back-end software application program running on one or more servers, and a front-end software application program running on one or more personal computers. However, it is understood that both the back-end and front-end application programs can be performed on a variety of processing systems. FIG. 1 illustrates an example of a suitable general computing system environment 100 on which the back-end and/or front-end application programs may be implemented. The computing system environment 100 is only one example of a suitable computing environment and is not intended to suggest any limitation as to the scope of use or functionality of the invention.

The invention is operational with numerous other general purpose or special purpose computing systems, environments or configurations. Examples of well known computing systems, environments and/or configurations that may be suitable for use with the invention include, but are not limited to, personal computers, server computers, multiprocessor systems, microprocessor-based systems, set top boxes, programmable consumer electronics, network PCs, minicomputers, mainframe computers, laptop and palm computers, hand held devices including personal digital assistants (PDAs) and cellular telephones, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 130 includes computer storage media in the form of volatile and/or nonvolatile memory such as read only memory 131 (ROM) and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. These components can either be the same as or different from operating system 134, application programs 135, other program modules 136, and program data 137. Operating system 144, application programs 145, other program modules 146, and program data 147 are given different numbers here to illustrate that, at a minimum, they are different copies. A rep may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computer 110 may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The application programs 135 stored in system memory 130 may include the front-end and/or back-end application programs for performing the present invention as described hereinafter. When the application program is launched, it runs on the operating system 134 while executing on the processing unit 120. An example of an operating system on which the front-end and/or back-end application program may run is the Macintosh operating system by Apple Computer, Inc. and the Windows® operating system from Microsoft Corporation. The front-end and/or back-end application programs may be loaded into the memory 130 from the CD-ROM 155, or alternatively, downloaded from network 171 or 173.

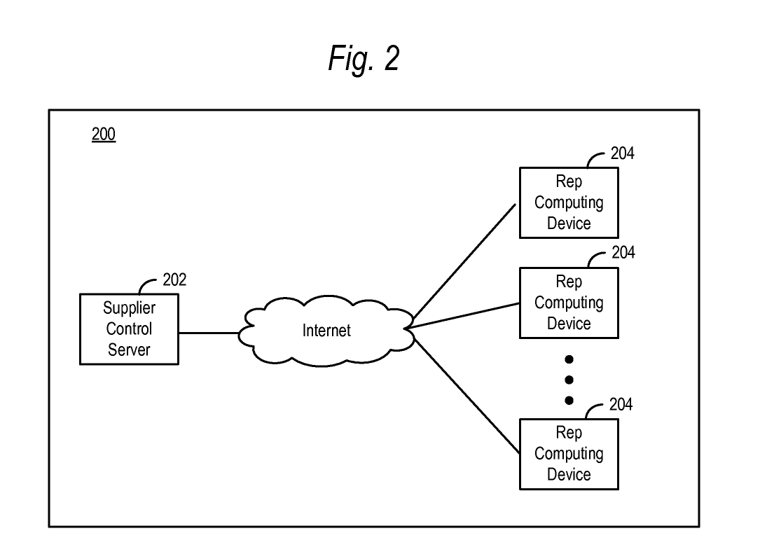

Referring now to FIG. 2, there is shown a network 200 including a control server 202 which in embodiments is administered by a supplier in a distribution channel. In an alternative embodiment, the control server 202 may be administered by an application service provider as host for multiple supplier customers, each having their own secure database and application instance. The control server 202 is networked to a plurality of computing devices 204 administered by sales representatives of the supplier (typically referred to herein as simply “reps”). In the embodiments described below, the distribution channel has three tiers. A supplier who provides products to a distributor, who in turn distributes to retailers. It is understood that the present invention may operate with more than three tiers in a distribution channel in alternative embodiments. In such embodiments, the control server 202 and computing devices 204 may be administered by other than a supplier and the supplier's reps.

In embodiments, the server 202 may be a Windows 2003 Server with SQL Server 2000, but server 202 may run other operating systems and other database management systems in alternative embodiments. The server 202 may be connected to the computing devices 204 via the Internet, but may be connected by a LAN or other network in addition to or instead of the Internet in alternative embodiments. While a single server 202 is shown, it is understood that server 202 may comprise a plurality of servers, and one of the servers may be a web server. In embodiments, the communications methodology between the control server and the client computer(s) may be based on an XML Web Services protocol, enabling flexible network topologies.

Server 202 is provided for implementing a back-end of the software application program according to the present invention. In particular, server 202 includes a database for storing information about supplier reps, distributors working with the supplier reps, and retailers that sell, have sold or may sell the supplier's products. In addition, server 202 stores historical sales information for products purchased by retailers. In an embodiment, server 202 may store, for each product supplied by the supplier, the purchases made by each retailer for example in the previous year by month. It is understood that the historical sales data may be kept for periods longer or shorter than a year in alternative embodiments. This data may be generated by the supplier itself, which collects it from downstream vendors. Alternatively or additionally, this data may be obtained from brokers which collect, clean and warehouse this data. Such known brokers include A C Nielsen and IRI.

The supplier may also generate a list of alerts, or messages, that are also stored within server 202. These messages may be associated with particular SKUs for particular retailers by an account status software engine included as part of the back-end application program according to the present invention. While embodiments include rules at the SKU level, alternative embodiments contemplate rules to be created at any level of the product hierarchy, and map to any level and/or attribute of the account hierarchy. For example, a rule can be created for a given SKU in a given geography; or given brand in a given channel type.

In further embodiments, the account status software engine may alternatively be included as part of the front-end application program. In such embodiments, the messages would be associated with particular SKUs for particular retailers within the reps' computing devices 204 as opposed to within server 202.

As explained in greater detail hereinafter, a message may automatically be appended by the account status software engine to a particular SKU of a particular retailer based on the purchasing history of that SKU by that retailer. For example, if purchases of a product by a retailer declined in the last 30 days, a low priority warning message may be generated and stored in association with that product for that retailer. The low priority warning message may be something like, “declining sales for one month.” If purchases of a product by a retailer declined over the last 60 days, a medium priority warning message may be generated and stored in association with that product for that retailer. The medium priority warning message may be something like, “declining sales for two months.” If purchases of a product by a retailer declined over the last 90 days, a high priority warning message may be generated and stored in association with that product for that retailer. The high priority warning message may be something like, “declining sales for three months,” or “buy trend failure.”

It is understood that a wide variety of other messages may be generated by a supplier for association with a particular retailer's product or retailer. In a further example, a rule might reflect the supplier's sales goals; e.g., 2% increase per customer per quarter. In that case, the alert might be generated if sales were flat instead of growing.

The server 202 may additionally store notes in association with a particular retailer, either associated with particular products for that retailer or simply associated with the retailer in general. These notes may be generated by the reps and uploaded to the server 202 as explained hereinafter. The server 202 may also be configured to send emails (or cause emails to be sent) to a particular rep computing device 204 or to all rep computing devices 204. The email message may be triggered by a variety of situations, such as for example as an alert that a particular buying trend has been identified with respect to a retail account of a particular rep.

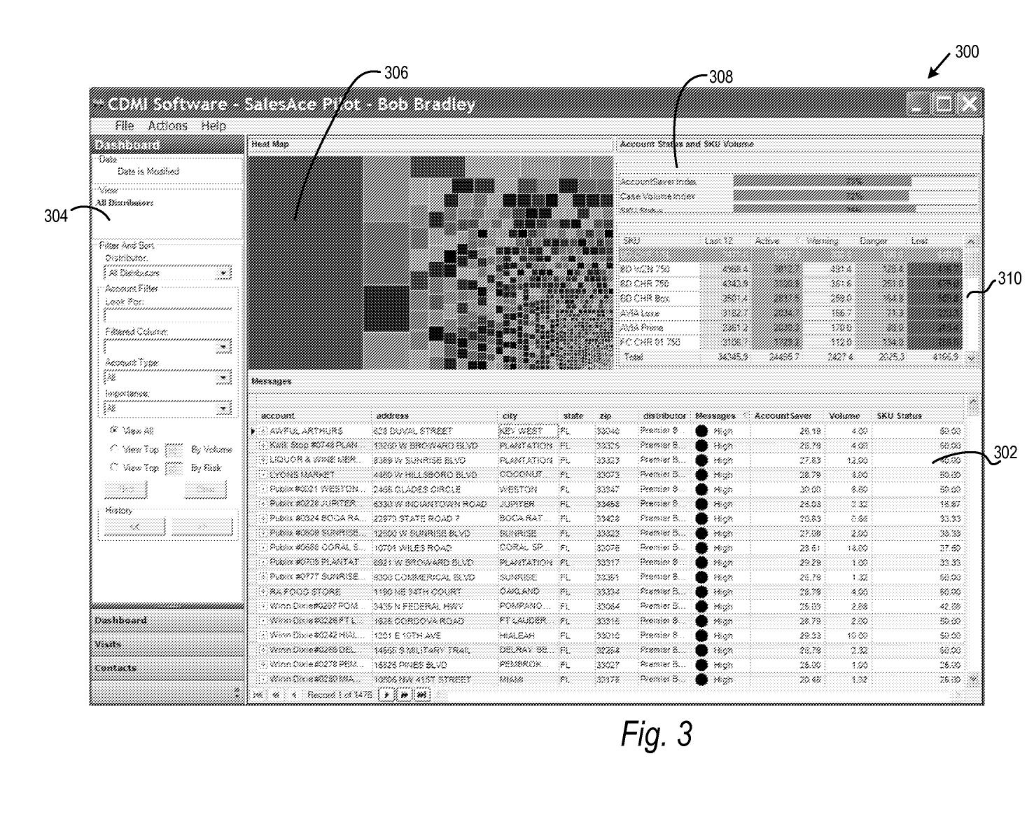

A front-end software application program according to the present invention may be implemented on the reps' computing devices 204. The front-end software application program in general stores data in memory of a computing device 204, and presents a rep with a graphical user interface (FIGS. 3 through 9 described hereinafter). The application program may be downloaded from server 202 or elsewhere, and then stored and run locally on a rep computing device 204. Alternatively, the application program may be stored and run remotely from server 202. In such embodiments, a rep may access and run the application program using an Internet browser and/or another client application stored on a rep computing device 202.

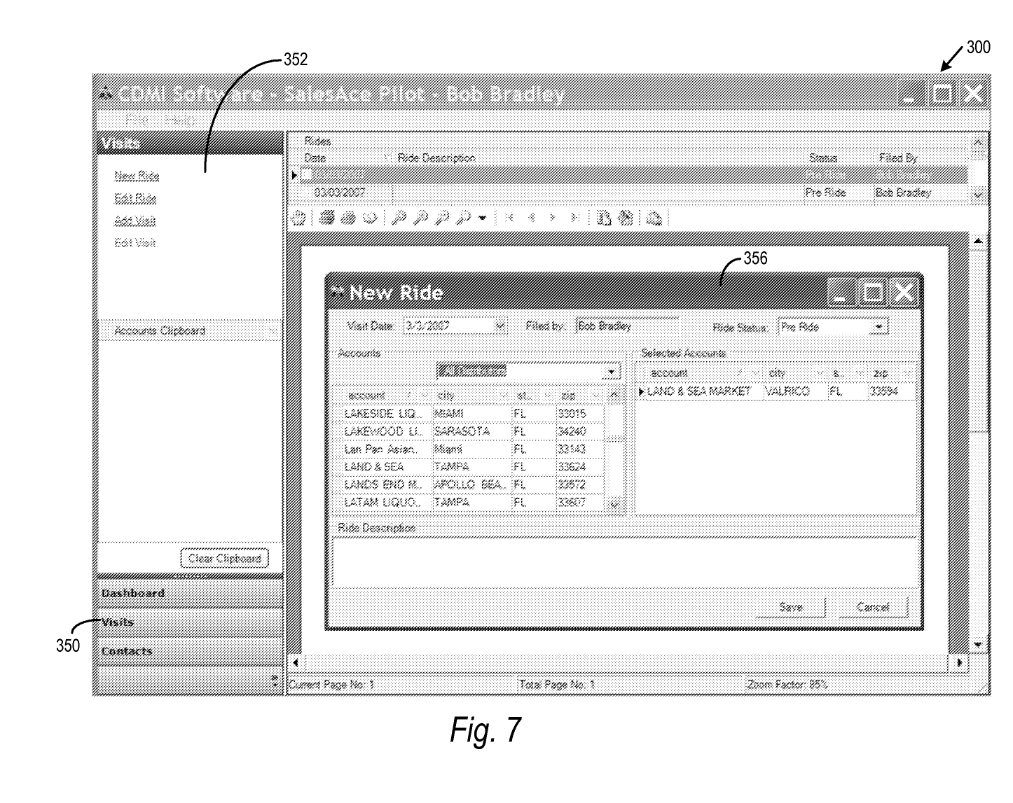

Upon launch, the front-end application program may present a rep with a graphical user interface 300 such as shown in FIG. 3. In embodiments, the user interface 300 may present a rep with different windows, such as for example a “dashboard,” as shown in FIG. 3, and a “visits” window, as shown in FIG. 7. Each of these screens is explained hereinafter. The dashboard user interface screen may present a rep with five fields: an account list and message field 302, a user input field 304, a heat map 306, an account status field 308 and a sales volume field 310. Each of these fields, and their functions, are explained hereinafter.

Account list and message field 302 displays a list of all accounts within a reps' territory to which a supplier's products are supplied, have been supplied and/or may be supplied. This information may be downloaded to a computing device 204 from server 202 and stored in a database associated with a rep computing device 204. A database management system may also be included in a rep computing device 204 to manage and query the database of stored account information. In embodiments, the account information represents retailers selling to the general public within a particular rep's territory.

The account list and message field 302 may have a variety of sub-fields including, for each account, the account name, address, distributor servicing the account, messages for the account, and an account saver index, volume and SKU status for each account. The account saver index, volume and SKU status for each account are explained in greater detail hereinafter. The message field indicates the type of messages that have been attached by the account status software engine to particular products of particular retail accounts. As indicated, the messages may be attached to a particular retailer's products at the server level or at the rep computing device level. In embodiments, the messages may be “high,” “medium,” “low” or just “info.”

As discussed above, a high priority message may mean that there have been declining sales of a product for 3 months. Alternatively, in some distribution channels, based on considerations of product, channel and timeframe, it has been determined that no sales for 3 months represents a buy trend failure, i.e., the retailer has no further interest in purchasing that product. Accordingly, for such distribution channels, a high priority message may signify a buy trend failure of a retail account for a given product. It is understood that other considerations may be factored in, such as seasonality and order patterns, to vary the length of time after which a buy trend failure is considered to have occurred. A medium priority message may mean declining sales for a product for 2 months. A low priority message may mean declining sales for a product for 1 month. An “info” message may not relate to declining sales, but rather may be some other note attached to an account's products or to the account in general by a rep as explained hereinafter.

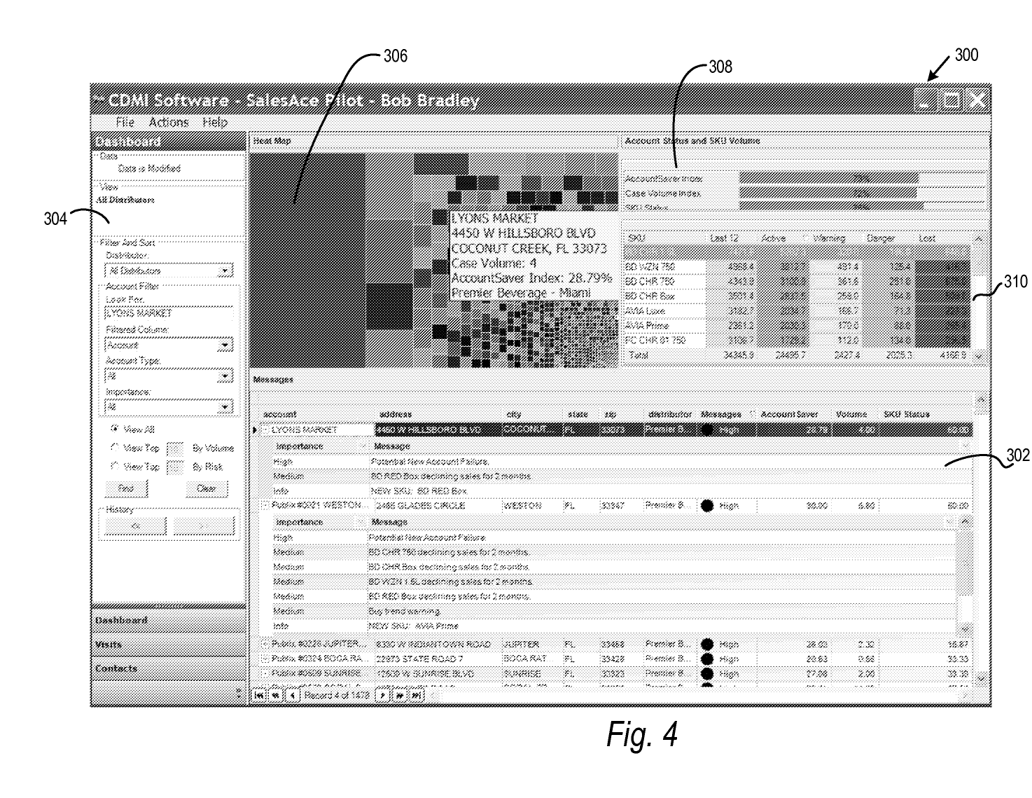

Upon clicking on an account shown in the account list and message field 302, the account may be expanded on the display to show any messages associated with that account. For example, as shown in FIG. 4, a rep has expanded the messages associated with the “Lyons Market” and “Publix” accounts. The messages display a particular SKU and then the message associated with that SKU. So for the Publix account, there is a high priority message indicating a potential account failure for a particular SKU, and a number of medium priority messages indicating declining sales for a number of SKUs for 2 months.

While the accounts shown in account list and message field 302 are accounts in geographical areas within Florida, USA, it is understood that the accounts may cover any geographical area in the United States and/or the world. In embodiments, a rep may have the ability to customize the sub-fields in the account list and message field 302. For example, a rep may organize the listing of accounts by a particular sub-field by clicking on the heading of a particular sub-field. Thus, for example, a rep may list accounts alphabetically by clicking on the account name sub-field, or a rep may sort accounts in order of ascending or descending message importance by clicking on the message sub-field. In further embodiments, a rep may have the ability to customize the account list and message field 302 by adding and/or removing certain sub-fields. This may be accomplished for example from a menu presented to a rep when the rep right clicks on a graphical pointing device with the cursor positioned over a particular sub-field.

As the accounts within the account list and message field 302 may be quite large, a rep may filter the accounts displayed via user input field 304. For example, user input field 304 may allow a rep to filter by distributor, by account name or address, by account type and/or by message type. It is understood that additional filters may be provided for a rep to filter the accounts displayed in the account list and message field 302. Based on information provided by a rep in the user input field, the database management system may select the applicable accounts for display in account list and message field 302.

Each of the accounts listed in account list and message field 302 may additionally be represented schematically within the heat map 306. Heat map 306 in general provides a rep with a comprehensive view of their territory, and highlights the health of different accounts. Each active account for the rep is represented by a graphical object, such as for example by the rectangles as shown in FIGS. 3-6. The graphical objects may be other shapes in alternative embodiments. Each graphical object within heat map 306 may have a size and a color representing characteristics of the associated account. For example, the volume of sales of a given account relative to other accounts may be indicated by the size of the associated graphical object relative to the other graphical objects within heat map 306. The larger the sales volume of an account, the larger the graphical object relative to the other objects.

In addition to size, each graphical object may have a color representing a certain characteristic of an account, such as for example the account saver index. As explained hereinafter, the account saver index of an account in general refers to the health of an account, and is normalized from 100 down to 0 relative to other accounts. A color scheme may be developed where each color represents a particular account saver index range. Thus, those accounts having the highest account saver index may receive a first color, such as for example bright green. Accounts having a mid-range account saver index may receive a second color, such as for example dark green or black, and accounts having a low account saver index may be shown in red on heat map 206. The colors set forth above are by way of example only and may vary in alternative embodiments. In embodiments, there may be six different color gradations representing six different account saver index ranges and six different degrees of health of an account. It is understood that the number of color gradations representing distinct account saver index ranges may be less than or greater than six in further embodiments of the invention. It is also true that a supplier may set up the heat map so that the size and/or colors of the geographic objects represent account metrics other than those described above in alternative embodiments.

The heat map 306 is one example of a visualization technique commonly referred to as “tree-mapping.” The size of the rectangles represents the relative magnitude of a data element in one dimension compared to other data elements and to the total of all elements in that dimension. This dimension is typically continuous-valued, such as revenue or volume. The color of the rectangle represents the value of each data element in second dimension, which may be continuously-valued and bracketed, or a limited number of discrete values (human ability to perceive differences in a spectrum of colors is the gating factor). In the embodiment, size represents volume, and color represents the computed health index of the account (range from bright green through black to bright red, for very good to neutral to very bad, with several intervals between). It is understood that a wide variety of other types of tree-maps may be used to highlight two dimensions of a data space.

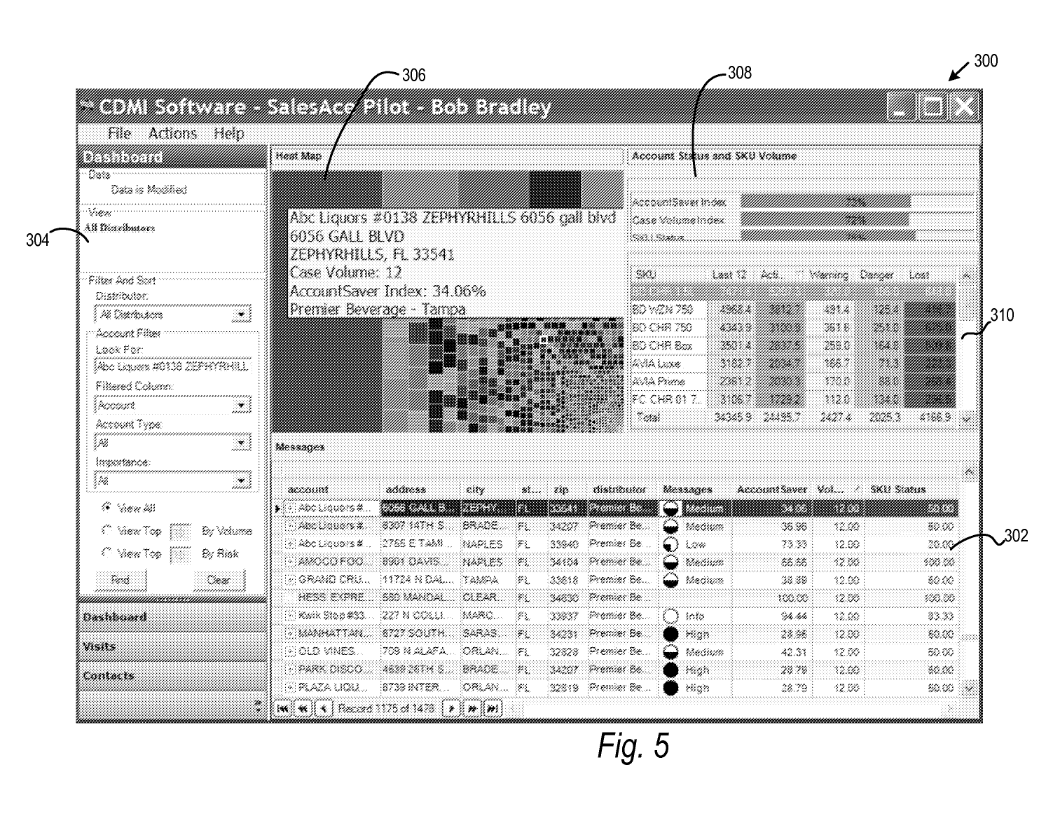

Referring now to the illustration of graphical user interface 300 shown in FIG. 5, when a rep selects a particular account from account list and message field 302, the geometric object in heat map 306 representing that account may be highlighted and the account information for the selected account may also be displayed on heat map 306. The account information for the different accounts may also be displayed on heat map 306 by a rep hovering over (i.e., positioning the cursor over) respective geometric objects.

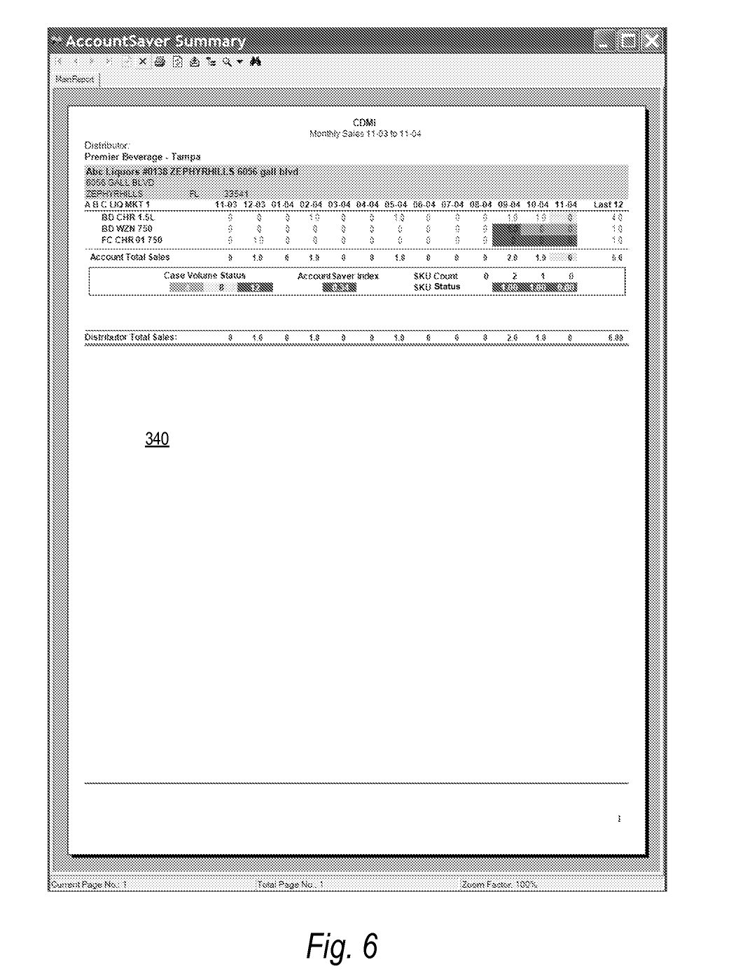

In the example of FIG. 5, the rep has selected ABC Liquors. If the rep double clicks on the ABC Liquors account (from the account list and message field 302 or from heat map 306), the application program may generate an account saver index summary on the display which is formatted for convenient printing. Referring to FIG. 6, an account saver index summery 340 may include account identification and address information, a listing of the SKUs for the account, historical sales data, and a listing of the volume status, account saver index and SKU trend for the account.

Volume status, SKU status and account saver index are part of the metrics that may be developed and implemented by a supplier to allow the reps to monitor the health of individual accounts and their account territory as a whole. It is understood that a wide variety of different health metrics may be developed and implemented by a supplier, and that different suppliers in different distribution channels may have different metrics. In an embodiment of the present invention, volume status, SKU status and the account saver index are used. These concepts are explained in the following paragraphs.

In general, the indexes reflect the aggregate health of the selected subset of accounts. An embodiment includes three metrics, each standardized to a 0-100 scale: volume trend (based on history); SKU mix trend (based on history); and a composite measure equally weighted between volume and mix. Any of these indexes and the formulation for the composite measure can be changed in the rule engine on the server.

The volume status is a measure of total shipment volume into an account or group of accounts, and reflects the overall volume trend of shipments into the account(s). The volume status may be used to calculate a volume index. Volume index simply measures whether volume is increasing, decreasing, or staying the same. 100% is no change, and anything less than 100% indicates a decline. Growing sales are not measured differentially. Thus, the index highlights problems, not wins. It is understood that wins may be factored in in alternative embodiments. This rule may be modified to reflect a target growth rate, so that 100% is sales on-target or above, and anything less than 100% is sales less than target. It is also possible to construct the volume index metric so that certain product lines or SKUs have a higher weighting in the volume index, making it possible for the metric to reflect growth goals in specific areas.

The SKU status is a measure of the product mix being shipped into an account or group of accounts, and reflects the penetration of the supplier's product line(s) into the account(s). As an example of a rule that may be implemented, if an account is carrying one-half of the supplier's products and continues to do so (even if the specific composition of products changes), then they are stable at 100%. The metric is gauged to spot losses in brand penetration. It is also possible to enhance this metric so that a greater importance can be placed on whether an account is carrying specific lines, if the mix deteriorates (for example from premium brands to bargain brands), seasonality, and so forth.

In embodiments, the account saver index is a simple weighted average of the case volume and SKU status. At different market entry stages, either volume or SKU mix may be more important to the supplier, so a supplier may vary the significance and weight of the two metrics in the account saver index. In an embodiment, the weighting is 50/50, so the account saver index, AS index, may be computed as:

AS index=0.5*CV Index+0.5*SKU Index.

The AS Index gives a useful top-level view of the individual accounts and territory. Again, these metrics are only one example of the metrics that a supplier may implement. One of the benefits of this feature is that the supplier is able to set the metrics that its reps use to measure account health. This accomplishes two goals. First, it ensures that the reps are focusing on the metrics that are important to the supplier. Second, it ensures uniformity in the way account health is measured and managed.

FIG. 6 also shows the concept of indicating account trends and health using visuals on the display. In the embodiment of FIG. 6, SKUs purchased in a given time period may be color coded with either a green, yellow, orange or red color. A green color code indicates a continued, healthy buying trend over that time period. A yellow color code indicates a decreasing buying trend over a single time period, for example the previous month. An orange color code indicates a decreasing buying trend over the previous two time periods, for example the previous two months. And a red color code indicates a decreasing buying trend over the previous three time periods, for example the previous three months. The warning, danger, and lost timeframes may be variable by brand/SKU, and may reflect the expected sales trend of the item(s). The color coding provides a visual indication of the health of a SKU and corresponds to the low, medium and high priority messages associated with the account SKUs. The normal, warning, danger and loss flags may or may not correspond to messages. This may be a supplier implementation decision.

Referring again to FIGS. 3 through 5, the account status field 308 is provided to display at a glance the metrics and overall health of the accounts within the territory. In the embodiment shown in FIGS. 3 through 5, the account status field 308 shows the overall account saver index, volume index and SKU status for all of the selected accounts together (after any filters have been applied).

Sales volume field 310 lists the SKUs provided by a supplier, along with the sales volume of the SKUs over a historical period, for example the previous twelve months. In an alternative embodiment, the list may be collapsed to show the SKUs by brand hierarchy, possibly showing a wide variety of levels of detail. The distribution channel and SKUs shown in FIGS. 3 through 5 relate to the sale of wine. However, the SKUs may be that of any distribution channel. The sales volume field 310 further shows the sales volume of active SKUs (i.e., the volume of sales, by SKU, exhibiting a continued buy trend); the sales volume of warning SKUs (i.e., the volume of sales, by SKU, exhibiting a decreasing buy trend for a single period); the sales volume of danger SKUs (i.e., the volume of sales, by SKU, exhibiting a decreasing buy trend for the last two periods); and the sales volume of lost SKUs (i.e., the volume of sales, by SKU, exhibiting a decreasing buy trend for the last three periods). The respective active, warning, danger and lost categories may be color coded as described above. Again, it is understood that a supplier may choose to exhibit a different historical sales metric instead of sales volume within field 310.

It may also be possible to right-click in section 310, upon which the application program presents a context-sensitive menu that enables account filtering on the selected row or cell. For example, one can find all accounts having a certain SKU with status=Danger.

As is known in the art, the size and aspect ratio of the different fields displayed on user interface 300 may be sized as desired by a rep. Thus, for example the size of the heat map 306 may be made larger so that the smaller volume accounts are more visible. Scroll bars may automatically be presented as is known where a field has more data than fits within the area sized for that field.

Referring now to the “visits” window of FIG. 7, in addition to providing account health information at a glance, the application program according to the present invention also allows supplier's representatives to better plan, manage and conduct field visits to retail accounts. The application program further allows a rep to report results of a field visit and to plan follow-up action items for those visits. As shown in FIG. 7, a rep may access portions of the graphical user interface 300 relating to field visits by selecting a visit tab 350 on user interface 300. Once selected, a rep is presented with a user input field 352 allowing a rep to set up a new field visit, referred to herein as a “ride,” edit an existing ride, add a new visit or edit a visit. As used herein, a ride is a grouping of field appointments, which may be comprised of multiple visits to different accounts. Sales reps can create ride plans based on dates, target customers, specific distributor objectives, etc.

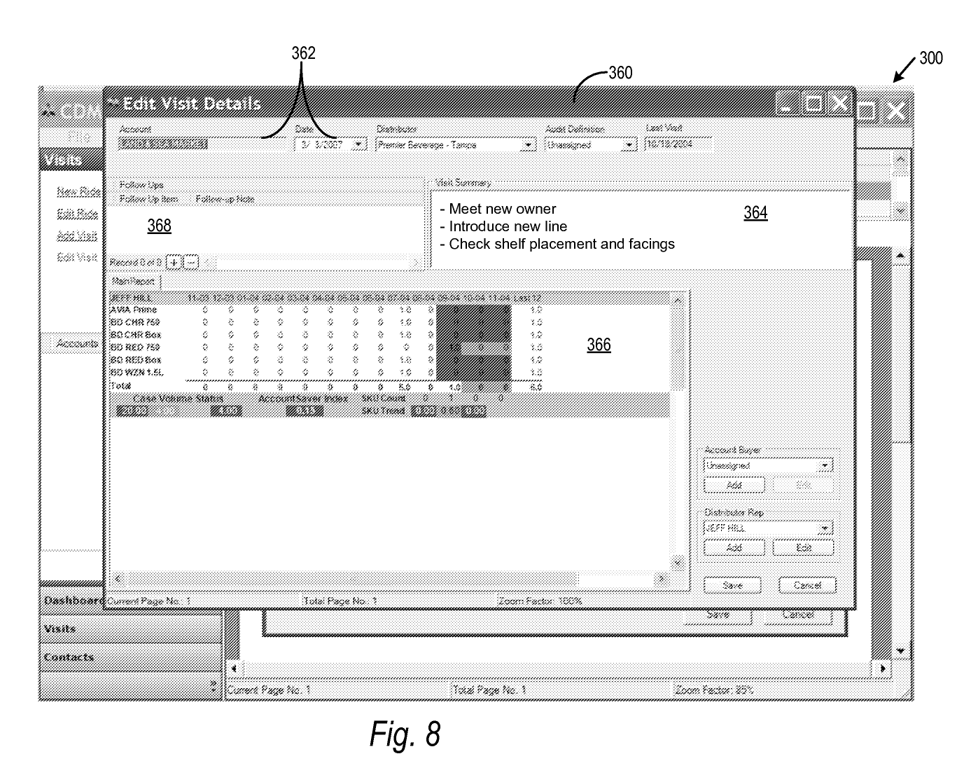

When a rep for example selects the new ride option, a window 356 may then be presented on graphical user interface 300. A rep may select one or more accounts for which a visit is to be set up by double clicking an account within window 356, or by dragging an account from the left to the right hand side. In the example of FIG. 7, the rep has selected to set up a ride including a visit to an account having a name “Land & Sea Market.” When a rep selects the “save” option once an account is selected in window 356, the rep is presented with a new window 360 (FIG. 8) allowing the rep to set up and edit the details of the visit.

The edit visit detail window 360 has several fields including visit identification fields 362 with account name, date of visit, distributor servicing the account and date of last visit. The edit visit detail window 360 further includes field 364 within which the rep may enter notes relating to the purpose of the visit. Edit visit detail window 360 may further include an account status window 366 including sales volume of different SKUs for some preceding period of time, for example a year, as well as the case value status, account saver index and SKU count for the selected account. Window 366 is automatically populated from the database of stored sales information once the account to be visited is selected.

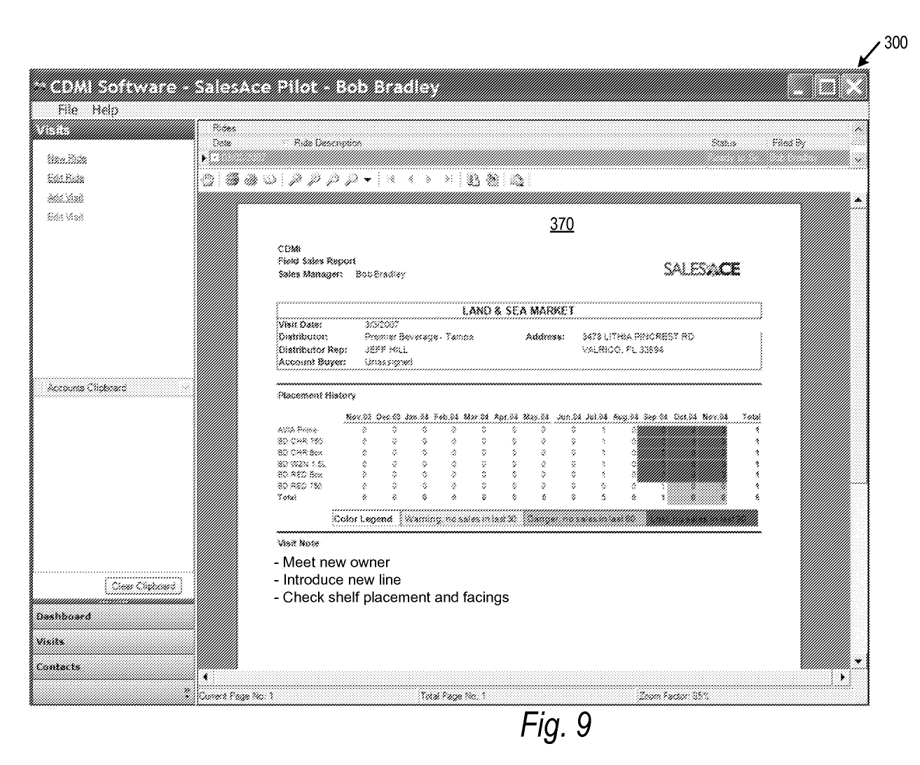

After entering visit notes in field 364, the rep may save edit visit detail window 360. Thereafter, the application program may generate a field visit form 370 on the display, a portion of which is shown in FIG. 9 that is formatted for convenient printing. Such a field visit form 370 may include all particulars the rep may need when conducting the field visit. The form 370 may include all the account contact information, a historical and current picture of the health of the account, and visit notes added by the rep in field 364 in edit visit detail window 360.

The rep may print out form 370 and bring it with him/her on the field visit. However, instead of or in addition to printing form 370, the rep may bring a portable computing device and access the front-end portion of the application program while at an account.

After a ride is completed (or while at an account), the rep may edit the ride by again accessing the edit visit detail window 360 (FIG. 8) to include survey information and follow-up notes in a field 368 on action items going forward for the accounts visited. The survey information may be what the rep observed at the account and may be useful in understanding any continued or declining sales trends indicated by the data. For example, a rep may learn that a negative sales trend was in fact due to a SKU never being put out on the shelves, or the position of a SKU being rearranged to less attractive shelf space. The follow-up notes may relate to action items to be taken in the future, with respect to the retail account and/or distributor servicing the retail account. The survey information and follow-up notes may be selected from predefined fields provided in the edit visit detail window 360. Providing pre-defined survey and follow-up notes allows a supplier to set priorities regarding survey items and follow-up action items for its reps. However, the edit visit detail window 360 may also accept user-defined survey information and follow-up notes.

The built-in list of action items and follow-up notes is changeable by each supplier at the server. Also, the particular survey to use is typically tied to the supplier type, though it may vary based on a specific sales program in force at any time, again, driven by the server configuration set by the supplier.

After a ride, the rep may also update a status of the ride by changing the status of form 370 to “Ready to Send.” This option may be selected from a drop down menu (not shown) under the File option on the window toolbar. When the rep is next connected to the Internet, the rep may choose “Send and Receive Data” from the File menu. This establishes a connection with server 202 and sends all the survey information from the visit, any notes and action items back to the central server 202. The server 202 may also download any new information relevant to the rep's accounts at this time. The rep can also generate a local report of the visit reports which he sends to the visited accounts, the responsible distributor and his/her management, if desired.

The application program according to the above-described embodiments provides several advantages allowing reps to manage downstream channel members. It allows reps to understand account buying trends, and to stay familiar with account history. It provides historical sales data and prior visit reports at a glance. It allows reps to make a more informed and focused inspection of an account retailer, specifically inspecting those aspects of an account deemed to be important by supplier management. After making such an inspection, the present system also provides reps with the tools to take appropriate action and to make reports quickly and easily as desired by supplier management.

A further advantage is sales force consistency from the supplier's point of view. In particular, the creation of a cross-organizational set of rules allows the supplier to drive sales force behavior. By having a consistent set of warnings and rankings, every sales rep views their territory in the same way, and it becomes easier, at least indirectly, to enforce sales priorities. A given set of rules may reflect a supplier's prioritization of reach (distribution depth), revenue (volume shipped) or retention (product mix and/or retailer consistency). The rule base may change at any time, reflecting short-term priorities such as promotions and/or new product roll-outs. One sort of alert may be for example, “This customer is an excellent candidate for new Brand X” or “This customer is an excellent candidate for a volume order this season.”

As a further advantage, reps can more effectively manage their relationships with the middle tier partner(s). By understanding what is happening at retail (which they do not directly service), the rep can guide/influence/educate their distributor partner to better service the retail end-customer.

In the embodiments described above, the application program according to the present invention is a useful tool for organizing and managing downstream activity in a distribution channel. However, in further embodiments of the invention, the application program may be useful in managing upstream relationships and activity as well. For example, a sales rep may need to interact with other divisions within the supplier, such as sales, marketing, accounting and corporate management. The present invention may generate reports, as described for example above with respect to field visit form 370, which may automatically be distributed to a variety of different departments with a supplier or elsewhere.

In the sideways and/or upward looking model, for the mid-tier implementation the notion of rules being generated by one or more suppliers may be incorporated, and used by the distributor sales rep to improve performance for the suppliers according to the suppliers' priorities. In this case, the distributor, who is balancing sometimes conflicting goals, can overlay the priorities of the upstream suppliers. A potential implementation would allow the distributor to overlay a further set of rules that prioritizes the rules of the individual suppliers based on goals that are local to the distributor.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A computer implemented method of managing distribution within a distribution channel, comprising the steps of:
(a) presenting an channel member with a graphical user interface including account information for at least one of upstream and downstream accounts;
(b) establishing a set of rules governing when an alert relating to the health of an account is to be generated in association with an account;
(c) generating one or more alerts relating to the health of an account in accordance with the set of rules established in said step (b); and
(d) presenting the one or more warning alerts generated in said step (c) with the account information presented in said step (a).

2. A computer implemented method as recited in claim 1, wherein the account is a downstream account, the method further comprising the steps of:
(a) generating a report relating to a survey and/or follow-up notes after a representative of the upstream channel member has visited a downstream account; and
(b) forwarding the report to one or more divisions within the upstream channel member.

3. A computer-readable medium as recited in claim 1, the method further comprising the step of presenting an upstream channel member with metrics indicative of health of the plurality of accounts as a whole.

4. A computer implemented method as recited in claim 1, wherein said step (c) of generating one or more alerts relating to the health of an account comprises the step of generating one or more alerts relating to the health of a SKU.

5. A computer implemented method as recited in claim 1, wherein said step (c) of generating one or more alerts relating to the health of an account comprises the step of generating an alert where there is a negative sales trend over a preceding time period.

6. A computer implemented method as recited in claim 1, wherein said step (c) of generating one or more alerts relating to the health of an account comprises the step of generating an alert where sales goals are not met.

7. A computer implemented method as recited in claim 1, wherein said step (c) of generating one or more alerts relating to the health of a SKU comprises the step of generating a first alert where there is a negative sales trend over a first preceding time period, a second alert where there is a negative sales trend over a second preceding time period, and a third alert where there is a negative sales trend over a third preceding time period.

8. A computer implemented method of managing distribution within a distribution channel, comprising the steps of:
(a) presenting an upstream channel member with a graphical user interface including account information for downstream accounts;
(b) establishing a set of rules governing when an alert relating to the health of a downstream account is to be generated in association with a downstream account;
(c) generating one or more alerts relating to the health of an account in accordance with the set of rules established in said step (b);
(d) presenting the one or more warning alerts generated in said step (c) with the account information presented in said step (a);
(e) generating a report relating to a survey and/or follow-up notes after a representative of the upstream channel member has visited a downstream account; and
(f) forwarding the report to one or more divisions within the upstream channel member.

9. A computer implemented method as recited in claim 8, wherein said step (c) of generating one or more alerts relating to the health of an account comprises the step of generating one or more alerts relating to the health of a SKU.

10. A computer implemented method as recited in claim 8, wherein said step (c) of generating one or more alerts relating to the health of an account comprises the step of generating one or more alerts relating to the health of at least one of brand, line, variety, package.

11. A computer implemented method as recited in claim 8, wherein said step (c) of generating one or more alerts relating to the health of an account comprises the step of generating an alert where there is a negative sales trend over a preceding time period.

12. A computer implemented method as recited in claim 8, wherein said step (c) of generating one or more alerts relating to the health of an account comprises the step of generating an alert where sales goals are not met.

13. A computer implemented method as recited in claim 8, wherein said step (c) of generating one or more alerts relating to the health of a SKU comprises the step of generating a first alert where there is a negative sales trend over a first preceding time period, a second alert where there is a negative sales trend over a second preceding time period, and a third alert where there is a negative sales trend over a third preceding time period.

14. A computer-readable medium having computer-executable instructions for programming a processor to perform a method of managing distribution within a distribution channel, the method comprising the steps of:
(a) presenting an upstream channel member with a graphical user interface including account information for downstream accounts;
(b) presenting the upstream channel member with a graphical user interface including historical sales information of the downstream accounts;
(c) generating one or more alerts relating to the health of an account;
(d) presenting the one or more warning alerts generated in said step (b) with the account information presented in said step (a);
(e) generating a report relating to a survey and/or follow-up notes after a representative of the upstream channel member has visited a downstream account; and
(f) forwarding the report to one or more divisions within the upstream channel member.

15. A computer-readable medium as recited in claim 14, the method further comprising the step of presenting the upstream channel member with metrics indicative of health of the plurality of accounts as a whole.

16. A computer implemented method as recited in claim 14, wherein said step (c) of generating one or more alerts relating to the health of an account comprises the step of generating one or more alerts relating to the health of a SKU.

17. A computer implemented method as recited in claim 14, wherein said step (c) of generating one or more alerts relating to the health of an account comprises the step of generating one or more alerts relating to the health of at least one of brand, line, variety, package.

18. A computer implemented method as recited in claim 14, wherein said step (c) of generating one or more alerts relating to the health of an account comprises the step of generating an alert where there is a negative sales trend over a preceding time period.

19. A computer implemented method as recited in claim 14, wherein said step (c) of generating one or more alerts relating to the health of an account comprises the step of generating an alert where sales goals are not met.

20. In a computer system having a graphical user interface including a display and a user interface selection device, a method of an upstream channel member managing distribution to a downstream channel member within a distribution channel, the method comprising the steps of:
(a) displaying a list of accounts;
(b) displaying a heat map including a plurality of geometric objects representing respective accounts listed in said step (a);
(c) displaying the geometric objects with a visual indicator indicating a health of the represented accounts;
(d) accepting user input for generating a field visit form used in a visit to an account, the user input relating to predefined metrics relating to a health of the account;
(e) accepting user input for modifying the field visit form generated in said step (d) to include information relating to the field visit after the field visit has been conducted; and
(f) accepting user input causing the field visit form modified in said step (e) to be forwarded to one or more divisions within the upstream channel member.

21. A method as recited in claim 20, further comprising the step (g) of displaying metrics indicative of health of the plurality of accounts as a whole.

22. A method as recited in claim 20, wherein said step (f) of accepting user input causing the field visit form modified in said step (e) to be forwarded to one or more divisions within the upstream channel member comprises the step of connecting to a network and uploading data from the field visit form to a server.

23. A method as recited in claim 20, wherein said step (f) of accepting user input causing the field visit form modified in said step (e) to be forwarded to one or more divisions within the upstream channel member comprises the step of synchronizing data to and/or from a network server administered by the upstream channel member.

24. A method as recited in claim 20, wherein said step (f) of accepting user input causing the field visit form modified in said step (e) to be forwarded to one or more divisions within the upstream channel member comprises the step of distributing data relating to the field visit form to one or more of the sales division, marketing division, accounting division and corporate management division of the upstream channel member.
